(19) United States
(12) Patent Application Publication
(10) Pub. No.: US 2016/0121567 A1
(43) Pub. Date: May 5, 2016

(54) RUBBER V-BELT EXTRUSION MOLDING APPARATUS AND METHOD

(71) Applicant: SANLUX CO., LTD, Shaoxing County (CN)

(72) Inventors: Peisheng WU, Shaoxing County (CN); Shuixiang SHI, Shaoxing County (CN); Xinfu ZHU, Shaoxing County (TW); Lixiang WU, Shaoxing County (TW)

(21) Appl. No.: 14/929,764

(22) Filed: Nov. 2, 2015

(30) Foreign Application Priority Data
Oct. 31, 2014 (CN) 201410599615.0

(51) Int. Cl. B29D 29/10

(52) U.S. Cl. CPC B29D 29/10; B29K 2021/00

(57) ABSTRACT

Rubber V-belt extrusion molding apparatus and method are described herein. The rubber V-belt extrusion molding apparatus includes an extrusion device, a conveying belt, a cooling device, a storage device, a detection device, a rubber coating and cutting device, and a canvas wrapping device. A material is extruded by the extrusion device to form base compound rubber. The conveying belt conveys the base compound rubber. The cooling device cools the base compound rubber on the conveying belt. The storage device stores the base compound rubber cooled by the cooling device and conveys the base compound rubber to the rubber coating and cutting device. The detection device detects the cooled base compound rubber before storing. The rubber coating and cutting device coats a yarn blank with the base compound rubber conveyed by the storage device to form a yarn core. The canvas wrapping device wraps the yarn core with a rubberized canvas.

### CROSS-REFERENCE TO RELATED APPLICATIONS

This Non-provisional application claims priority under 35 U.S.C. §119(a) on Patent Application No(s). 201410599615.0 filed in Republic of China on Oct. 31, 2014, the entire contents of which are hereby incorporated by reference.

### BACKGROUND OF THE INVENTION

1. Field of the Invention

The present invention relates to the technical field of manufacturing of drive belt molding apparatus, and, more particularly, relates to rubber V-belt extrusion molding apparatus and method.

2. Description of the Related Art

A drive belt is a device for transferring power generated by rotation of a motor or an engine of a prime mover to mechanical apparatus through a rubber belt via a belt pulley. The drive belt is widely applied in the fields of motors, agricultural machines, machine tools, automobiles, ships, household appliances, office equipment and so on. The drive belt has the advantages of free speed change, far and near driving, simple structure and so on. A rubber V-belt is the most widely used one in drive belts.

According to an existing extrusion molding process for the rubber V-belt, an open mill is adopted for hot milling, base compound rubber is extruded by a hot feed extruder, a yarn blank is molded by a fiber yarn machine, and the yarn blank and the base compound rubber are attached and then wrapped with canvas to form the rubber V-belt. In the production process, the base compound rubber extruded by the extruder is not detected by a detection device, and because the base compound rubber is not sufficiently cooled, the precision of the base compound rubber is relatively low, and it is extremely easy to produce defective products. According to the existing rubber V-belt molding apparatus, the precision is low since the base compound rubber and rubberized canvas are manually cut. Moreover, when the base compound rubber is drawn and attached, the base compound rubber cannot be uniformly drawn according to the technical requirement, so that the weight uniformity of the base compound rubber is affected, defective products are easily produced, the canvas wrapping precision is low, and the defective rate is high.

In addition, according to the existing extrusion molding process for the rubber V-belt, one person can only manage one piece of rubber V-belt molding apparatus, so that the production efficiency is low and the corresponding production cost is high.

### BRIEF SUMMARY OF THE INVENTION

To overcome the defects of the prior art, the present invention provides rubber V-belt extrusion molding apparatus and method capable of greatly improving molding precision.

To achieve the above objectives, the present invention provides rubber V-belt extrusion molding apparatus including an extrusion device, a conveying belt, a cooling device, a storage device, a detection device, a rubber coating and cutting device, and a canvas wrapping device. The extrusion device includes a material inlet and a neck ring mold, and a material is extruded by the neck ring mold to form base compound rubber. The conveying belt is connected with the neck ring mold and conveys the formed base compound rubber. The cooling device is disposed at one side of the conveying belt and cools the base compound rubber on the conveying belt. The storage device is disposed at the cooling device and stores the base compound rubber after the base compound is cooled by the cooling device and conveys the base compound rubber to the rubber coating and cutting device. The detection device is disposed between the cooling device and the storage device and detects the base compound rubber before the base compound is stored. The rubber coating and cutting device coats a yarn blank with the base compound rubber conveyed by the storage device to form a yarn core. The canvas wrapping device wraps the yarn core formed by the rubber coating and cutting device with rubberized canvas.

In an embodiment of the present invention, the cooling device may include at least two cooling assemblies, and the detection device may be disposed between the at least two cooling assemblies.

In an embodiment of the present invention, the cooling device may include two cooling assemblies, namely a first cooling assembly and a second cooling assembly, the first cooling assembly may be a water cooling device, and the second cooling assembly may be an air cooling device.

In an embodiment of the present invention, the conveying belt may be disposed at the second cooling assembly in a Z shape.

In an embodiment of the present invention, the detection device may be a weight detection device.

In an embodiment of the present invention, a row of first rotating shafts for conveying the base compound rubber may be disposed at one end of the storage device, a row of second rotating shafts for conveying the base compound rubber may be disposed at the other end of the storage device, and the first rotating shafts and the second rotating shafts are staggered.

In an embodiment of the present invention, the diameter of the first rotating shaft may be greater than or equal to that of the second rotating shaft.

In an embodiment of the present invention, the rubber coating and cutting device may be numerically controlled and may include a rubber coating frame, a base compound rubber leading-out assembly, a base compound rubber conveying assembly, and a base compound rubber coating and cutting assembly. The base compound rubber leading-out assembly, the base compound rubber conveying assembly, and the base compound rubber coating and cutting assembly may be sequentially disposed at the rubber coating frame. The base compound rubber coating and cutting assembly may include a driving roller disposed at the rubber coating frame, a driven tensioning roller disposed at the rubber coating frame, grouped round cutting knives, and a squeezing roller. The squeezing roller may be positioned between the driving roller and the driven tensioning roller, and the grouped round cutting knives having a sliding mechanism may be disposed above the squeezing roller.

In an embodiment of the present invention, the canvas wrapping device may include a yarn mounting assembly, a conveying assembly, a canvas wrapping assembly, and a cutting assembly. The conveying assembly may convey the rubberized canvas to the yarn core to attach the yarn core. The canvas wrapping assembly may press the rubberized canvas to tightly attach the rubberized canvas to the yarn core, and the cutting assembly may cut off the rubberized canvas after canvas wrapping is completed.

In correspondence to the molding device, the present invention further provides a rubber V-belt extrusion molding method, including:

extruding a material to form base compound rubber;
conveying the formed base compound rubber;
cooling the base compound rubber on a conveying belt;
detecting the quality of the cooled base compound rubber, and judging whether the quality of the base compound rubber is qualified;
storing the qualified base compound rubber passing the detection;
coating the base compound rubber to a preplaced yarn blank to form a yarn core; and
wrapping the formed yarn core with rubberized canvas to form a rubber V-belt.

It could be known from the above technical solutions that, in the embodiments of the present invention, the base compound rubber formed by the extrusion device is sufficiently cooled and shaped by the cooling device. The detection device detects the quality of the formed base compound rubber in real time, and once unqualified base compound rubber is discovered, a user may timely check and overhaul whether the extrusion device and the cooling device run normally or not, so that a large quantity of unqualified products are avoided. The storage device may store the formed base compound rubber, so as to prevent the base compound rubber from being accumulated between the storage device and the rubber coating and cutting device. Moreover, the rubber coating and cutting device and the canvas wrapping device realize fully automatic rubber coating, base compound rubber cutting, canvas wrapping, and rubberized canvas cutting, and all procedures are fully automatically controlled, so that extremely high control precision is realized, and the precision and the yield of the formed rubber V-belt are greatly improved.

To make the above-mentioned and other purposes, features and advantages of the present invention more obvious and easily understood, preferred embodiments will be described in detail below in combination with the accompanying drawings.

### BRIEF DESCRIPTION OF THE DRAWINGS

FIG. 1 is a structural schematic diagram showing rubber V-belt extrusion molding apparatus according to one embodiment of the present invention;

FIG. 2 is a front view of a rubber coating and cutting device in FIG. 1;

FIG. 3 is a perspective view of the rubber coating and cutting device in FIG. 1;

FIG. 4 is an enlarged diagram of A in FIG. 3;

FIG. 5 is a front view of a canvas wrapping device in FIG. 1;

FIG. 6 is a top view of the canvas wrapping device in FIG. 1;

FIG. 7 is an enlarged diagram of B in FIG. 5; and

FIG. 8 is a flow diagram of a rubber V-belt extrusion molding method according to one embodiment of the present invention.

### DETAILED DESCRIPTION OF THE INVENTION

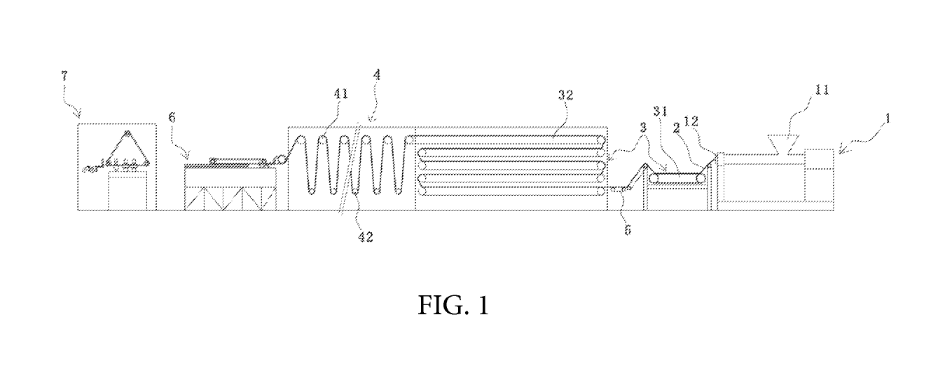

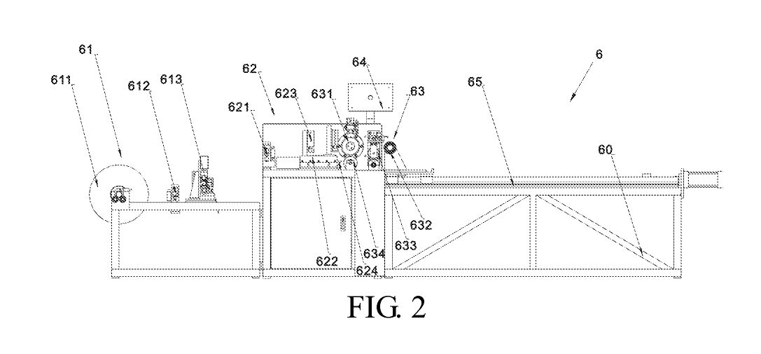

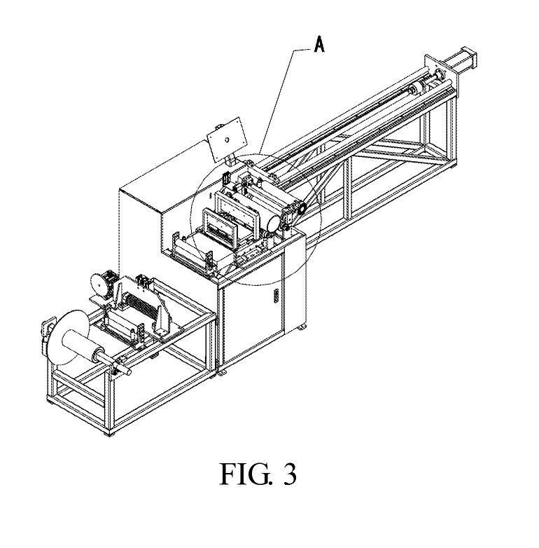

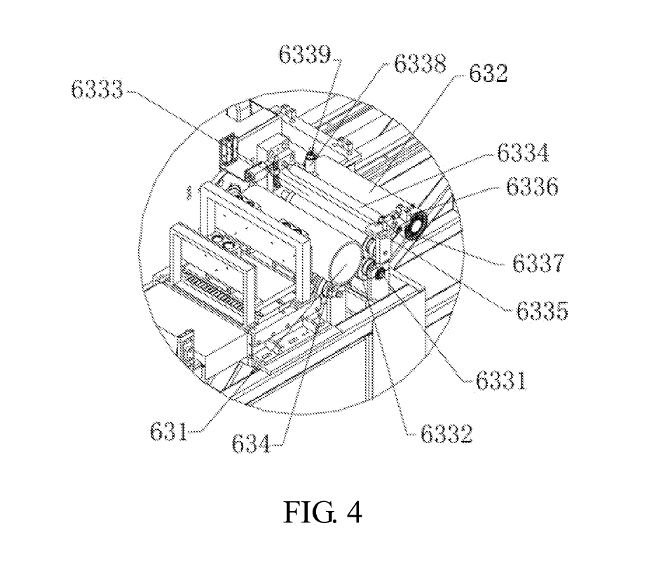

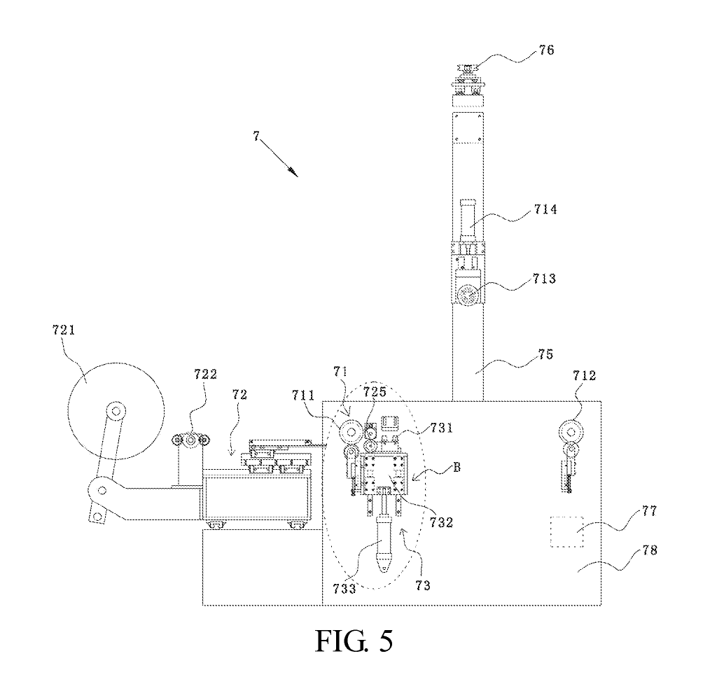

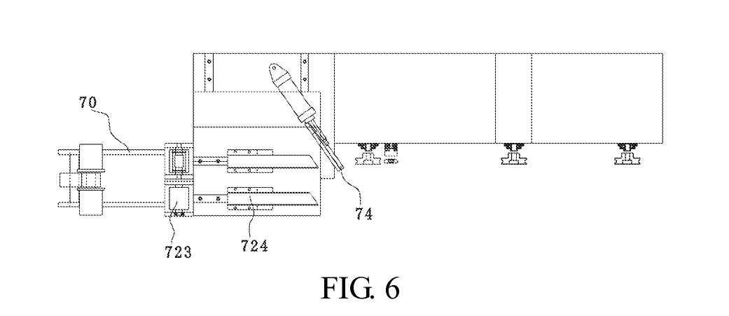

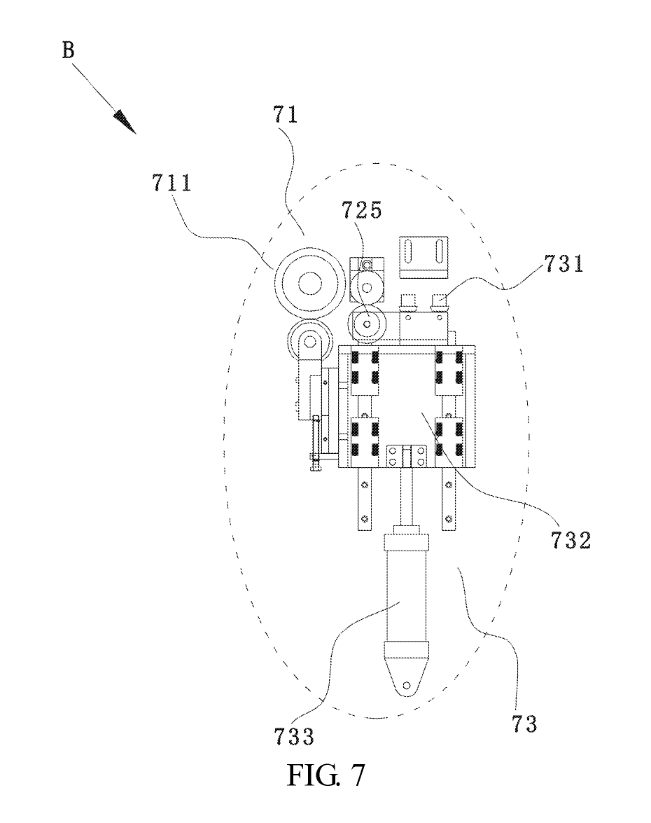

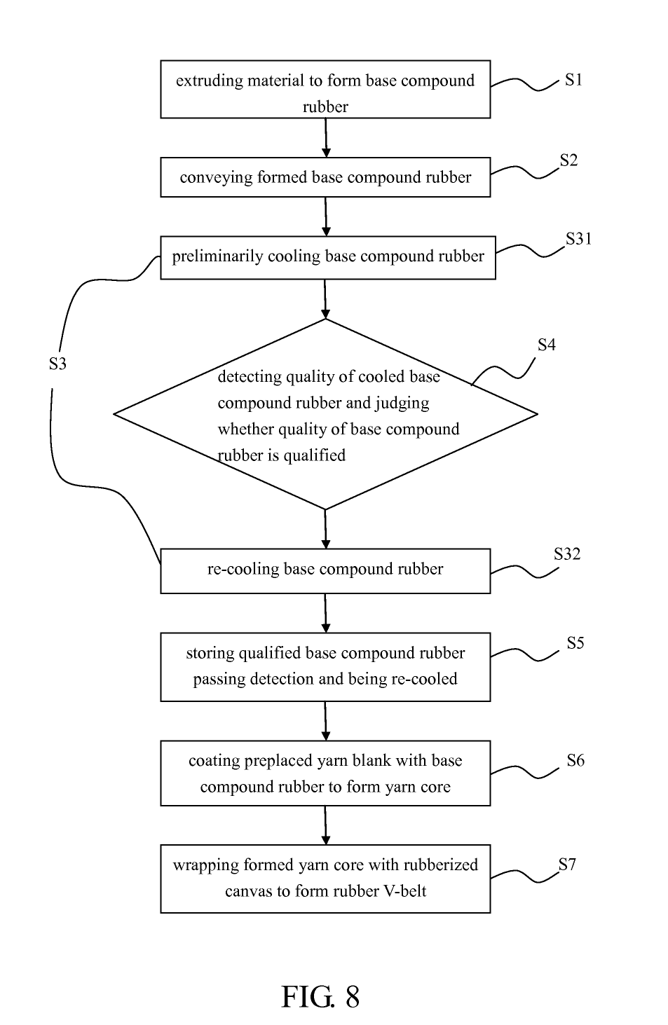

FIG. 1 is a structural schematic diagram showing rubber V-belt extrusion molding apparatus according to one embodiment of the present invention. FIG. 2 is a front view of a rubber coating and cutting device in FIG. 1. FIG. 3 is a perspective view of the rubber coating and cutting device in FIG. 1. FIG. 4 is an enlarged diagram of A in FIG. 3. FIG. 5 is a front view of a canvas wrapping device in FIG. 1. FIG. 6 is a top view of a canvas wrapping device in FIG. 1. FIG. 7 is an enlarged diagram of B in FIG. 5. FIG. 8 is a flow diagram of a rubber V-belt extrusion molding method according to one embodiment of the present invention.

As shown in FIG. 1, the rubber V-belt extrusion molding apparatus provided by the present invention includes an extrusion device 1, a conveying belt 2, a cooling device 3, a storage device 4, a detection device 5, a rubber coating and cutting device 6 (which is merely briefly shown in FIG. 1) and a canvas wrapping device 7 (which is merely briefly shown in FIG. 1). The extrusion device 1 includes a material inlet 11 and a neck ring mold 12, and a material is extruded by the neck ring mold 12 to form base compound rubber. The conveying belt 2 is connected with the neck ring mold 12 and conveys the formed base compound rubber. The cooling device 3 is disposed at one side of the conveying belt 2 and cools the base compound rubber on the conveying belt 2. In this embodiment, the extrusion device 1 is a cold feed extruder.

To better cool the base compound rubber, the cooling device 3 includes at least two cooling assemblies. In this embodiment, the cooling device 3 includes two cooling assemblies, namely a first cooling assembly 31 and a second cooling assembly 32. However, the number of the cooling assemblies is not limited in the present invention.

Preferably, the first cooling assembly 31 is a water cooling device with relatively low cost. The first cooling assembly 31 includes a cold water pipeline disposed below the conveying belt 2, and cooling water circularly flows in the cold water pipeline to take away heat of the base compound rubber on the conveying belt 2 so as to preliminarily cool the base compound rubber. To further cool the base compound rubber, the second cooling assembly 32 adopts an air cooling device with relatively high cooling efficiency. In this embodiment, two rows of rotating shafts are disposed at the left and right sides of the second cooling assembly 32, respectively, and the conveying belt 2 is disposed at the second cooling assembly 32 in a longitudinal Z shape. Through Z-shaped arrangement, the contact area between the base compound rubber on the conveying belt 2 and cooling air is greatly enlarged, and the effect of quickly cooling the base compound rubber is achieved.

However, the structures of the first cooling assembly 31 and the second cooling assembly 32 are not limited in the present invention. In other embodiments, other cooling medium with better cooling effect may be adopted in the first cooling assembly 31, or the first cooling assembly 31 adopts an air cooling device which is the same as that adopted by the second cooling assembly 32. The rotating shafts in the second cooling assembly 32 may be disposed at the upper end and lower end of the second cooling assembly 32, respectively, and the conveying belt 2 is disposed at the second cooling assembly 32 in a transverse Z shape.

The detection device 5 is disposed between the first cooling assembly 31 and the second cooling assembly 32 and is used for detecting the base compound rubber preliminarily cooled by the first cooling assembly 31 in real time. Once the detection device 5 detects that the weight of the base compound rubber is unqualified, a user may timely check and overhaul the extrusion device 1 and the first cooling assembly 31 which mainly affect the base compound rubber forming quality. Unqualified products are greatly reduced through the device. Meanwhile, apparatus after the detection device 5 do not need to produce the unqualified products, so that the production cost of the unqualified products is greatly reduced. However, the invention is not limited thereto. In other embodiments, the detection device 5 may be disposed after the second cooling assembly 32.

In this embodiment, the detection device 5 is a weight detection device. Preferably, the detection device 5 is a scale weighing each meter of the base compound rubber and is disposed below the conveying belt 2. However, the invention is not limited thereto. In other embodiments, the detection device 5 may be other equipment for detecting the weight and detecting the precision of the base compound rubber.

In practical production, because the speed of extruding and forming the base compound rubber by the extrusion device 1 is high, whereas the latter rubber coating and cutting device 6 is limited by the length of a yarn blank and the process conditions such as rubber coating speed and so on, the speed of forming a yarn core is low. If the base compound rubber is directly conveyed from the second cooling assembly 32 to the rubber coating and cutting device 6, the base compound rubber is folded and stacked between the second cooling assembly 32 and the rubber coating and cutting device 6. Since the surface of the base compound rubber has certain viscosity, the stacked base compound rubber would be adhered together and may not be separated. Thus, the subsequent rubber coating procedure may not be carried out; and even if the base compound rubber may be separated, the surface of the base compound rubber is damaged, so that subsequent rubber coating and the quality of a belt core after the rubber coating are seriously affected.

In view of this, in this embodiment, the qualified base compound rubber passing the detection is not directly conveyed to the rubber coating and cutting device 6 after being further cooled and shaped by the second cooling assembly 32, but conveyed to the storage device 4 between the second cooling assembly 32 and the rubber coating and cutting device 6. The storage device 4 stores the surplus base compound rubber.

A row of first rotating shafts 41 for conveying the base compound rubber is disposed at one end of the storage device 4, a row of second rotating shafts 42 for conveying the base compound rubber is disposed at the other end of the storage device 4, and the first rotating shafts 41 and the second rotating shafts 42 are staggered. In this embodiment, multiple rows of first rotating shafts 41 for conveying the base compound rubber are transversely disposed at the upper end of the storage device 4, and multiple rows of second rotating shafts 42 for conveying the base compound rubber are transversely disposed at the lower end of the storage device 4. As shown in FIG. 1, one second rotating shaft 42 is disposed between two adjacent first rotating shafts 41, so that when the base compound rubber is conveyed between the first rotating shafts 41 and the second rotating shafts 42, a traction force from right to left is formed for conveniently discharging the base compound rubber from the storage device 4 to the rubber coating and cutting device 6.

In this embodiment, to further increase the traction force from right to left, the diameter of the first rotating shafts 41 is not smaller than that of the second rotating shafts 42. Preferably, the diameter of the first rotating shafts 41 is greater than that of the second rotating shafts 42. Thus, a larger traction force from right to left is formed between the first rotating shafts 41 and the second rotating shafts 42, which is more favorable for discharging the base compound rubber.

However, the positions of the first rotating shafts 41 and the second rotating shafts 42 are not limited in the present invention. In other embodiments, the first rotating shafts 41 and the second rotating shafts 42 may be disposed at the left and right ends of the storage device 4 in a mutually staggered manner, and the base compound rubber is transversely drawn to and fro. At the moment, due to the limitation of the quantity of the first rotating shafts 41 and the second rotating shafts 42, the length of the storage device 4 may be greater than the width thereof. Accordingly, a user may select the arrangement positions of the first rotating shafts 41 and the second rotating shafts 42 according to the site condition of the device.

In this embodiment, the rubber coating and cutting device 6 is numerically controlled and includes a rubber coating frame 60, a base compound rubber leading-out assembly 61, a base compound rubber conveying assembly 62, and a base compound rubber coating and cutting assembly 63. The base compound rubber leading-out assembly 61, the base compound rubber conveying assembly 62, and the base compound rubber coating and cutting assembly 63 are sequentially disposed at the rubber coating frame 60 from left to right. The rubber coating and cutting device 6 further includes a rubber coating numeric control assembly 64.

The rubber coating frame 60 is mounted on the ground and plays a role in supporting the whole cutting device.

The leftmost is the base compound rubber leading-out assembly 61, and the base compound rubber leading-out assembly 61 includes a base compound rubber reel 611, a base compound rubber flattening mechanism 612, and a base compound rubber leading-out mechanism 613. The base compound rubber reel 611, the base compound rubber flattening mechanism 612, and the base compound rubber leading-out mechanism 613 are sequentially mounted on the rubber coating frame 60.

The base compound rubber reel 611 is a part where a base compound rubber raw material is stored and delivered, and the base compound rubber raw material is reeled on the base compound rubber reel 611 for later use.

The base compound rubber flattening mechanism 612 is used for flattening the base compound rubber conveyed by the base compound rubber reel 611 to facilitate a latter coating procedure.

The base compound rubber leading-out mechanism 613 electrically leads out and conveys the base compound rubber to the base compound rubber conveying assembly 62.

The base compound rubber conveying assembly 62 sequentially includes a base compound rubber guiding pressing block 621, a base compound rubber conveying rack 622, a base compound rubber clamping mechanism 623, and a base compound rubber oblique cutting tool 624. The base compound rubber guiding pressing block 621 and the base compound rubber conveying rack 622 are mounted on the rubber coating frame 60 from left to right. The base compound rubber clamping mechanism 623 and the base compound rubber oblique cutting tool 624 are disposed at the base compound rubber conveying rack 622.

The base compound rubber clamping mechanism 623 is used for clamping and fixing the base compound rubber. The base compound rubber is conveyed from the base compound rubber leading-out mechanism 613, and after being clamped by the base compound rubber clamping mechanism 623, the base compound rubber is conveyed to the base compound rubber guiding pressing block 621 for guiding.

The base compound rubber oblique cutting tool 624 is used for cutting off the grouped base compound rubber.

The base compound rubber coating and cutting mechanism 63 includes a driving roller 631, a driven tensioning roller 632, and a cutting mechanism 633. The driving roller 631, the driven tensioning roller 632, and the cutting mechanism 633 are disposed at the rubber coating frame 60. In this embodiment, the base compound rubber coating and cutting mechanism 63 further includes a base compound rubber pressing roller 634 cooperating with the driving roller 631.

A yarn blank is loaded onto the driving roller 631 and the driven tensioning roller 632.

The base compound rubber pressing roller 634 is disposed below the driving roller 631 for pressing the grouped base compound rubber onto the yarn blank on the driving roller 631.

FIG. 4 is a partial enlarged schematic diagram of A in FIG. 3. It could be seen from FIG. 3 that, the cutting mechanism 633 includes a grouped round cutting knives 6331 and a squeezing roller 6332. Since several cords of the yarn blank form a group and the yarn blank is cut by groups of the cords, the grouped round cutting knives 101 refer that the number of the round cutting knives corresponds to the number of the cords in one group.

The squeezing roller 6332 is positioned between the driving roller 631 and the driven tensioning roller 632, and the grouped round cutting knives 6331 is disposed above the squeezing roller 6332.

The grouped round cutting knives 6331 are used for cutting the yarn blank on which the base compound rubber has already been coated in a grouped manner and are provided with a sliding mechanism. The sliding mechanism includes a synchronous belt pulley (not shown in the figure), a mold plate 6333, and a movable lead screw 6334.

The synchronous belt pulley is disposed at the rubber coating frame 60 and provided with a drive motor. A data acquisition unit is disposed at a rotating shaft of the drive motor and automatically controlled by a programmable logic controller (PLC) control system in the rubber coating numeric control assembly 64, and the data acquisition unit transmits data to the PLC control system so as to accurately control the displacement of the grouped round cutting knives 6331.

The mold plate 6333 is disposed above the grouped round cutting knives 6331, and an upper mold 6336 and a lower mold 6335 are further disposed on the mold plate 6333. The upper mold 6336 and the lower mold 6335 may be in various shapes as required. In one preferred embodiment, both the upper mold 6336 and the lower mold 6335 are dovetail shaped.

A distance adjusting mechanism 6337 is disposed on the lower mold 6335 and includes a distance adjusting device disposed on the lower mold 6335.

The grouped round cutting knives 6331 are positioned below the distance adjusting mechanism 6337 and locked by a core shaft and a spacing gasket.

A guide post 6339 is disposed on the mold plate 6333 for accurately positioning the grouped round cutting knives 6331. The guide post 6339 is positioned in a guide sleeve 6338 disposed at the rubber coating frame 60.

The movable lead screw 6334 is disposed on the mold plate 6333 and engaged with the synchronous belt pulley. The grouped round cutting knives 6331 slide up and down through rotation of concentric double shafts. Specifically, the drive motor drives a synchronous belt, and a shaft of the synchronous belt pulley rotates on the rubber coating frame 60 in a gapless manner under the action of upper and lower thrust bearings; and the center of the shaft of the synchronous belt pulley is engaged with the movable lead screw 6334, and when the synchronous belt pulley rotates, the movable lead screw 6334 is engaged to slide up and down, so that tight transmission of double shafts is realized. Therefore, the grouped round cutting knives 6331 can slide up and down.

When the rubber V-belt coating and cutting device in the present invention works, a power supply is started, the type specification of the yarn blank is input on the rubber coating numerical control assembly 64, the driven tensioning roller 632 is automatically fed to a standard size, and the yarn blank is loaded onto the driving roller 631 and the driven tensioning roller 632. The driven tensioning roller 632 tensions automatically, the driving roller 631 rotates. Then the yarn blank is positioned, and the yarn blank is flattened at the same time.

The base compound rubber on the base compound rubber reel 611 passes through the base compound rubber flattening mechanism 612 and is electrically led out from the base compound rubber leading-out mechanism 613. The led out base compound rubber is clamped by the base compound rubber clamping mechanism 624 and conveyed to the base compound rubber guiding pressing block 621. After being guided, the base compound rubber is obliquely cut by the base compound rubber oblique cutting tool 624; and then the grouped base compound rubber is attached to the yarn blank on the driving roller 631 by the base compound rubber conveying rack 622.

The base compound rubber pressing roller 634 tightly presses the grouped base compound rubber onto the yarn blank on the driving roller 631. Under automatic control of the numerical control panel 64, the base compound rubber is pressed tightly onto the yarn blank and attached around the yarn blank, then the base compound rubber is obliquely cut by the base compound rubber oblique cutting tool 624, and the base compound rubber is automatically lapped and pressed. After the base compound rubber oblique cutting tool 624 cuts off the base compound rubber, the rest grouped base compound rubber automatically and horizontally exits a coating state by the base compound rubber conveying rack 622 and waits for next mold operation.

After the base compound rubber is coated, when the attached base compound rubber and yarn blank pass through the base compound rubber yarn blank cutting mechanism 633, the grouped round cutting knives 6331 of the base compound rubber yarn blank cutting mechanism 633 rises automatically, so that the attached base compound rubber and yarn blank can pass through; and then the grouped round cutting knives 6331 move downwards under the action of the sliding mechanism to cut into intervals and belt pitches of each group of cords till cutting to the squeezing roller 6332 to realize automatic cutting of the base compound rubber and the yarn blank by groups. Therefore, the base compound rubber and the yarn blank are separated from each other strip by strip.

The attached base compound rubber and yarn blank are rotated for one circle by the driving roller 631 and completely separated by the base compound rubber yarn blank cutting mechanism 633, and the whole base compound rubber and yarn blank coating and cutting operation is completed. The driven tensioning roller 632 moves horizontally and relaxes in a rubber coating guide rail 65. The yarn blank is coated with the rubber to form a yarn core.

The yarn core is fixed on a yarn core fixing assembly 71 on the canvas wrapping device 7, and the yarn core fixing assembly 71 drives the yarn core to rotate. A conveying assembly 72 conveys the rubberized canvas to attach the yarn core. At that time, a canvas wrapping assembly 73 which is disposed vertical to the rotating direction of the yarn core and disposed on one side of the yarn core fixing assembly 71 reciprocates continuously to squeeze the rubberized canvas, so that the rubberized canvas is bonded with the yarn core. After a layer of rubberized canvas is wrapped, a cutting assembly 74 automatically cuts off the rubberized canvas. The next layer of rubberized canvas is replaced by the conveying assembly 72, the above-mentioned wrapping process is repeated, and a rubber V-belt is formed after multiple times of wrapping.

In this embodiment, both the canvas conveying assembly 72 and the cutting assembly 74 are disposed at a canvas wrapping frame 70. The canvas conveying assembly 72 includes a rubberized canvas reel 721 for fixing the rubberized canvas, a canvas conveying wheel 722 for providing power for conveying the rubberized canvas, a canvas replacing assembly 723 for replacing the rubberized canvas of different wrapping layers, and a canvas conveying platform 724.

The yarn core fixing assembly 71 consists of a driving wheel 711 and a driven wheel 712. Further, in order to better adjust the drawing effect of the yarn core thus to obtain better uniformity when the rubberized canvas is attached, the yarn core fixing assembly 71 further includes a tensioning wheel 713 in this embodiment. The tensioning wheel 713 may adjust the tensioning force of the yarn core on the driving wheel 711 and the driven wheel 712. In this embodiment, a tensioning cylinder 714 for controlling the tensioning state of the tensioning wheel 713 is further disposed at one side of the tensioning wheel 713, and the tensioning wheel 713 is disposed on a guide rail 75.

In practical use, for the rubber V-belt in different specifications and types, the drawing length required by the yarn core is also different, that is, the distance between the tensioning wheel 713 and the driving wheel 711 and the distance between the tensioning wheel 713 and the driven wheel 712 are different. In this embodiment, to achieve the canvas wrapping and processing of the rubber V-belt in different specifications and types so as to improve the universality of the automatic coating machine, a center distance adjusting assembly 76 for adjusting the center distance between the tensioning wheel 713 and the driving wheel 711 and the center distance between the tensioning wheel 713 and the driven wheel 712 is mounted on the guide rail 715. In the practical use process, the control system automatically adjusts the center distance adjusting assembly 76 according to the specification of the rubber V-belt to be processed, so that the tensioning wheel 713 automatically runs to the required size. In this embodiment, the center distance adjusting assembly 76 is an adjusting valve. However, the invention is not limited thereto.

In this embodiment, the canvas wrapping assembly 73 includes a canvas wrapping roller 731, a canvas wrapping guide rail assembly 732 connected with the canvas wrapping roller 731, and a canvas wrapping telescopic cylinder 733 for driving the canvas wrapping guide rail assembly 732 to move. The canvas wrapping telescopic cylinder 733 provides a reciprocating driving force to drive the canvas wrapping guide rail assembly 732 to reciprocate along the direction vertical to the conveying direction of the canvas conveying assembly 72, to continuously push the canvas wrapping roller 731 to the rubberized canvas, so that the rubberized canvas is sufficiently bonded with the yarn core to complete canvas wrapping. However, the specific structure of the canvas wrapping device 3 in the invention is not limited thereto. In other embodiments, the canvas wrapping device 73 may be a squeezing device, such as a spring, for realizing reciprocating movements.

In the practical canvas wrapping process, since the rubberized canvas has certain elasticity, the edge of the rubberized canvas may be warped during the conveying process. Thus, the conveyed rubberized canvas may be folded, which is not favorable for subsequent conveying of the rubberized canvas and affects the canvas wrapping precision at the same time. In view of this, in this embodiment, the canvas conveying assembly 72 further includes a canvas pressing wheel 725 disposed between the yarn core mounting assembly 71 and the canvas wrapping device 73. During the conveying process of the rubberized canvas, the canvas pressing wheel 725 exerts certain pressure to the rubberized canvas, so that the edge of the rubberized canvas cannot be warped. Moreover, the process of conveying the rubberized canvas from the canvas pressing wheel 725 to attach the yarn core is very short, so that the rubberized canvas is unlikely to warp again. Therefore, the conveying of the rubberized canvas is facilitated, and the canvas wrapping precision is greatly improved at the same time.

In this embodiment, both the yarn core mounting assembly 72 and the canvas wrapping assembly 73 are disposed on a canvas wrapping host case 78, and a programmable logic controller (PLC) canvas wrapping control device 77 for controlling the canvas conveying assembly 71, the yarn core mounting assembly 72, the canvas wrapping assembly 73 and the cutting assembly 74 is further disposed in the host case 78. Under the control of the PLC canvas wrapping control assembly 77, the canvas conveying, canvas wrapping, and cutting are automatically completed.

The rubber V-belt extrusion molding method will be further described in detail below in combination with the above-mentioned rubber V-belt extrusion molding apparatus.

The rubber V-belt extrusion molding method provided by this embodiment includes the following steps.

Step S1: a material is extruded to form the base compound rubber. Specifically, mixed rubber is fed from the material inlet 11 of the extrusion device 1, and the base compound rubber with relatively high temperature is formed through the neck ring mold 12.

Step S2: the formed base compound rubber is conveyed. The formed base compound rubber with relatively high temperature is conveyed to the subsequent apparatus by the conveying belt 2.

Step S3: the base compound rubber on the conveying belt 2 is cooled. This step includes preliminary cooling the base compound rubber (Step S31) and re-cooling the base compound rubber (Step S32).

In Step S31, a relatively cheap water cooling device is adopted, and cooling water circularly flows in the water cooling device to cool the base compound rubber. The temperature of the cooling water is 5-15° C., and the flow rate of the cooling water is 0.5-2.0 meters per minute. Preferably, the temperature of the cooling water is 10° C., and the flow rate of the cooling water is 1.2 meters per minute. However, the invention is not limited thereto. In other embodiments, the temperature of the cooling water may be other value within 5 to 10° C., and the flow rate of the cooling water may also be other value within 0.5 to 2.0 meters per minute.

In Step S32, an air cooling device with relatively high cooling efficiency is adopted. In this embodiment, the speed of air output by the air cooling device is 70-150 meters per minute. Preferably, the speed of air output by the air cooling device is 110 meters per minute. However, the invention is not limited thereto. In other embodiments, the speed of air output by the air cooling device may be other value within 70-150 meters per minute.

In this embodiment, there is Step S4 between Step S31 and Step S32. However, the invention is not limited thereto. In other embodiments, Step S4 may be set after Step S32. Step S4 specifically involves in detecting the quality of the cooled base compound rubber and judging whether the quality of the base compound rubber is qualified. In this embodiment, whether the quality of the base compound rubber on the conveying belt meets the requirement is detected by the scale weighing each meter of the base compound rubber.

Step S5: the qualified base compound rubber passing the detection and being re-cooled is stored. In this step, the base compound rubber is stored between the first rotating shafts 41 and the second rotating shafts 42 on the storage device 4. The rotating speeds of the first rotating shafts 41 and the second rotating shafts 42 are set according to the subsequent rubber coating speed.

Step S6: the base compound rubber is coated on a preplaced yarn blank to form a yarn core. In this step, the rotating speed of the yarn blank fixing assembly 61 is 4-6 meters per minute, the speed of outputting the base compound rubber by the storage device 4 is 4-6 meters per minute, and the reciprocating motion speed of the rubber canvas wrapping assembly 61 is 2 meters per minute. Preferably, both the rotating speed of the yarn blank fixing assembly 61 and the speed of outputting the base compound rubber by the storage device 4 are 5 meters per minute. However,

Step S7: the outer part of the formed yarn core is wrapped with rubberized canvas to form a rubber V-belt. In this step, the rotating speed of the yarn core fixing device 71 is 10-20 meters per minute, the speed of conveying the rubberized canvas by the conveying device 72 is 10-20 meters per minute, and the moving speed of the canvas wrapping assembly 73 is 10-20 meters per minute. Preferably, the rotating speed of the yarn core fixing device 71, the speed of conveying the rubberized canvas by the conveying device 72, and the moving speed of the canvas wrapping assembly 73 are 15 meters per minute. However, the invention is not limited thereto.

In conclusion, in the embodiments of the present invention, the base compound rubber formed by the extrusion device 1 is sufficiently cooled and shaped by the cooling device 3. The detection device 3 detects the quality of the formed base compound rubber in real time, and once unqualified base compound rubber is discovered, a user may timely check and overhaul whether the extrusion device 1 and the cooling device 3 run normally or not, so that a large quantity of unqualified products are avoided. The storage device 5 may store the formed base compound rubber, so as to prevent the base compound rubber from being accumulated between the storage device 5 and the rubber coating and cutting device 6. Moreover, the rubber coating and cutting device 6 and the canvas wrapping device 7 realize fully automatic rubber coating, base compound rubber cutting, canvas wrapping, and rubberized canvas cutting, and all procedures are fully automatically controlled, so that extremely high control precision is realized, and the precision and the yield of the formed rubber V-belt are greatly improved.

Although the present invention is disclosed above with the preferred embodiments, the embodiments are not used for limiting the present invention. A little alteration and modification may be made by any skilled who is familiar with this technique without departing from the spirit and scope of the present invention. Accordingly, the protection scope of the claims should be under the control of the protection scope of the present invention.

What is claimed is:

1. Rubber V-belt extrusion molding apparatus, comprising:
an extrusion device, comprising a material inlet and a neck ring mold, wherein a material is extruded by the neck ring mold to form base compound rubber;
a conveying belt, connected with the neck ring mold and conveying the formed base compound rubber;
a cooling device, disposed at one side of the conveying belt and cooling the base compound rubber on the conveying belt;
a storage device, disposed at the cooling device, storing the base compound rubber after the base compound is cooled by the cooling device and conveying the base compound rubber to a rubber coating and cutting device;
a detection device, disposed between the cooling device and the storage device and detecting the cooled base compound rubber before the base compound is stored;
the rubber coating and cutting device, coating a yarn blank with the base compound rubber conveyed by the storage device to form a yarn core; and
a canvas wrapping device, wrapping the yarn core formed by the rubber coating and cutting device with rubberized canvas.

2. The rubber V-belt extrusion molding apparatus according to claim 1, wherein the cooling device comprises at least two cooling assemblies, and the detection device is disposed, between the at least two cooling assemblies.

3. The rubber V-belt extrusion molding apparatus according to claim 2, wherein the cooling device comprises two cooling assemblies, namely a first cooling assembly and a second cooling assembly, the first cooling assembly is a water cooling device, and the second cooling assembly is an air cooling device.

4. The rubber V-belt extrusion molding apparatus according to claim 3, wherein the conveying belt is disposed at the second cooling assembly in a Z shape.

5. The rubber V-belt extrusion molding apparatus according to claim 1, wherein the detection device is weight detection device.

6. The rubber V-belt extrusion molding apparatus according to claim 2, wherein the detection device is weight detection device.

7. The rubber V-belt extrusion molding apparatus according to claim 1, wherein a row of first rotating shafts for conveying the base compound rubber is disposed at one end of the storage device, a row of second rotating shafts for conveying the base compound rubber is disposed in parallel at the other end of the storage device, and the first rotating shafts and the second rotating shafts are staggered.

8. The rubber V-belt extrusion molding apparatus according to claim 7, wherein the diameter of the first rotating shaft is greater than or equal to that of the second rotating shaft.

9. The rubber V-belt extrusion molding apparatus according to claim 1, wherein the rubber coating and cutting device is numerically controlled and comprises a rubber coating frame, a base compound rubber leading-out assembly, a base compound rubber conveying assembly, and a base compound rubber coating and cutting assembly, the base compound rubber leading-out assembly, the base compound rubber conveying assembly, and the base compound rubber coating and cutting assembly are sequentially disposed at the rubber coating frame, the base compound rubber coating and cutting assembly comprises a driving roller disposed at the rubber coating frame, a driven tensioning roller disposed at the rubber coating frame, grouped round cutting knives, and a squeezing roller, the squeezing roller is positioned between the driving roller and the driven tensioning roller, and the grouped round cutting knives having a sliding mechanism are disposed above the squeezing roller.

10. The rubber V-belt extrusion molding apparatus according to claim 1, wherein the canvas wrapping device comprises a yarn mounting assembly, a conveying assembly, a canvas wrapping assembly, and a cutting assembly, the conveying assembly conveys the rubberized canvas to the yarn core to attach the yarn core, the canvas wrapping assembly presses the rubberized canvas to tightly attach the rubberized canvas to the yarn core, and the cutting assembly cuts off the rubberized canvas after canvas wrapping is completed.

11. A rubber V-belt extrusion molding method, comprising:
extruding a material to form base compound rubber;
conveying the formed base compound rubber;
cooling the base compound rubber on a conveying belt;
detecting the quality of the cooled base compound rubber and judging whether the quality of the base compound rubber is qualified;
storing the qualified base compound rubber passing the detection;
coating the base compound rubber to a preplaced yarn blank to form a yarn core; and
wrapping the formed yarn core with rubberized canvas to form a rubber V-belt.
